(19) United States
(12) Patent Application Publication
(10) Pub. No.: US 2007/0124426 A1
(43) Pub. Date: May 31, 2007

(54) Internet device providing quality and link information

(76) Inventor: Adolf Proidl, Vianna (AT)

Correspondence Address: PHILIPS INTELLECTUAL PROPERTY & STANDARDS, P.O. BOX 3001, BRIARCLIFF MANOR, NY, 10510, US

(21) Appl. No.: 10/525,175

(22) PCT Filed: Aug. 5, 2003
(86) PCT No.: PCT/IB03/03443

§ 371 Date: Nov. 2, 2005

(30) Foreign Application Priority Data
Aug. 26, 2002 (EP) 02102219.9

(51) Int. Cl. G06F 15/16

(52) U.S. Cl. 709/218

(57) ABSTRACT

A receiver (17, 18, 19, 20, 21) for receiving information data outputs feedback information (FI) to a device (1, 2, 3, 4, 5) provided for monitoring the retrievability of the information data (RD), which device (1, 2, 3, 4, 5) outputs fault report information to the devices (D2, 16) in the transmission path of the information data (RD) which are responsible for poor quality reception of information data (RD).

The invention relates to a receiver for receiving information data from information servers connected with a data network, having information retrieval means for retrieving information data from one of the information servers identified by data network addresses and having receiving means for receiving the retrieved information data from the information server and having quality testing means for testing the quality of the received information data and for outputting quality information.

The invention also relates to a receiving method for generating feedback information, having a receiver, connected with a data network, for an information server connected with the data network, the following steps being executed:

retrieval of the information data from one of the information servers identified by data network addresses and

reception of the retrieved information data from the information server and
testing of the quality of the received information data and outputting of quality information.

The invention also relates to an overview information server for outputting overview information to a receiver connected over a data network, the overview information identifying information servers and information data retrievable from these information servers with the receiver, said overview information server having receiving means for receiving query information from a receiver for retrieving the overview information and having memory means for storing the overview information and having transmitting means for transmitting the stored overview information to the retrieving receiver.

Such a receiver, such a receiving method and such an overview information server are known from document WO 02/25900 A1. Said document discloses a receiver which takes the form of an Internet radio. The Internet radio may be connected over the Internet with information servers. Information servers take the form, on the one hand, of radio stations which provide radio programs as information data retrievable for Internet radios. On the other hand, an overview information server constitutes an information server, from which overview information may be retrieved by the Internet radio. The overview information contains a list of Internet addresses and names of Internet radio stations and identifiers identifying which type of radio programs may be retrieved from the individual Internet radio stations.

The known Internet radio comprises quality testing means, so as to test the quality of the radio programs retrieved by the Internet radio. If the thus determined quality information identifies that the received information data exhibit a quality below a quality threshold, information retrieval means of the Internet radio retrieve the overview information anew from the overview information server. This makes it possible for the Internet radio station program displaying poor quality reception or not being received at all to be retrieved from another current Internet address of the radio station.

The known receiver and the known method exhibit the disadvantage that neither the overview information server nor the Internet radio station receives information as to whether the information data retrievable from the Internet radio station may actually be retrieved by Internet radios in any desired regions of the world.

It is an object of the invention to provide a receiver of the type indicated in the first paragraph, a receiving method of the type indicated in the second paragraph and an overview information server of the type indicated in the third paragraph, with which the above-mentioned disadvantages are avoided. To achieve the object indicated above, such a receiver is provided with feedback means which are designed to output feedback information to one of the information servers, wherein the feedback information contains the quality information and connection information identifying the link between the receiver and the data network.

To achieve the object indicated above, such a receiving method is characterized in that feedback information is output to one of the information servers, wherein the feedback information contains the quality information and connection information identifying the link between the receiver and the data network.

To achieve the object indicated above, such an overview information server is characterized in that the receiving means are designed to receive feedback information containing quality information and connection information, wherein the quality information identifies the quality of the information data received by the receiver from one of the information servers and the connection information identifies the link between the receiver and the data network.

The features according to the invention ensure that one of the information servers connected with the data network, which server is provided for monitoring the retrievability of the information data, receives the feedback information from the receiver. By evaluating the connection information, the operator of the information server may derive information about the receiver link. The connection information could for example contain information about the service provider via which the receiver is connected to the data network. Similarly, the connection information could contain information about the maximum bit rate transmissible by the service provider to the receiver. The quality information contains the quality (e.g. bit rate) of the retrieved information data actually received by the receiver. By jointly evaluating the connection information and the quality information of a large number of receivers, the information server may determine which receivers are having problems retrieving which information data. The information server provided for monitoring the retrievability of the information data may thus establish, for example, that the radio programs of the radio station CNN can be received only poorly or cannot be received at all in part of New York State by Internet radios which are connected with the Internet over a particular data network node or over a particular service provider.

In this way, the advantage is achieved that operators of the information server receiving the feedback information may get measures under way to eliminate the technical problems and to allow problem-free high-quality information data retrieval. Thus, the number of users of the information server (e.g. Internet radio station) may also be increased, which leads advantageously to higher advertising revenue for the information server.

It may be mentioned that a system is known from document US 2001/0034219 A1 in which Internet radios transmit information to an overview information server as to whether it has been possible successfully to create a connection with a particular Internet radio station. The known overview information server determines statistical information about the Internet radio stations, wherein it is determined to what extent information data may be retrieved from the individual Internet radio stations. However, known Internet radios do not transmit any connection information to the overview information server, for which reason detection according to the invention of technically problematic points in the information data transmission path from the information server to the receiver is not possible.

According to the measures of claims 2 and 10, the advantage is achieved that the operators of the information server outputting information data (e.g. Internet radio station, Internet television station, Video On Demand server, Electronic Program Guide server etc.) directly receive information about the geographic regions in which it is currently impossible to retrieve the information data. The operator of the information server may thus take direct action, such as contacting the operator of the service provider or of the data network node via which the receiver is attempting unsuccessfully to retrieve information data of sufficiently high quality, so as once again to ensure, as quickly as possible, high quality transmission of the information data to the customers (users of the receivers).

According to the measures of claims 3 and 11, the advantage is achieved that the operator of the overview information server, the “added value” of which lies in the provision of a list of available information servers, learns immediately from the receivers whether information servers to which the overview information server makes reference are exhibiting quality problems. The quality information transmitted by the receivers is 100% reliable (each failed connection set-up attempt is indicated), in contrast to the expensive, complex random measurements by information server operators. Furthermore, knowledge about current use and availability of information servers is of value to information server operators, service providers and market researchers, because, for example, it makes service providers better able to plan the structure of their network on the basis of information traffic development. Constant analysis of the weak points of their network, before actual failure occurs, is also of interest.

According to the measures of claim 4, the advantage is achieved that the connection information unambiguously identifies the service provider over which the receiver is connected to the Internet. In this way, the operator of the information server may directly contact the service provider if technical problems at the service provider's end are detected by evaluation of the feedback information, so as to bring the service provider's attention to the technical problems. In addition, the operator may use the substantiated level of service provider customer interest in its information server in negotiations with service providers in relation to service level agreements.

According to the measures of claim 7, the advantage is achieved that the receiver transmits the feedback information to the information server over an alternative data connection (e.g. telephone, modem, radio etc.) in the event of complete breakdown of the data connection between a receiver and an information server.

According to the measures of claim 13, the advantage is achieved that the overview information server evaluates the feedback information automatically and may automatically inform the competent authorities if problems occur with increasing frequency in relation to the reception of information data over a particular data network node or service provider. In this way, uniformly good reception of the information data is ensured for receivers in any desired geographical regions.

The invention will be further described with reference to examples of embodiments shown in the drawings to which, however, the invention is not restricted.

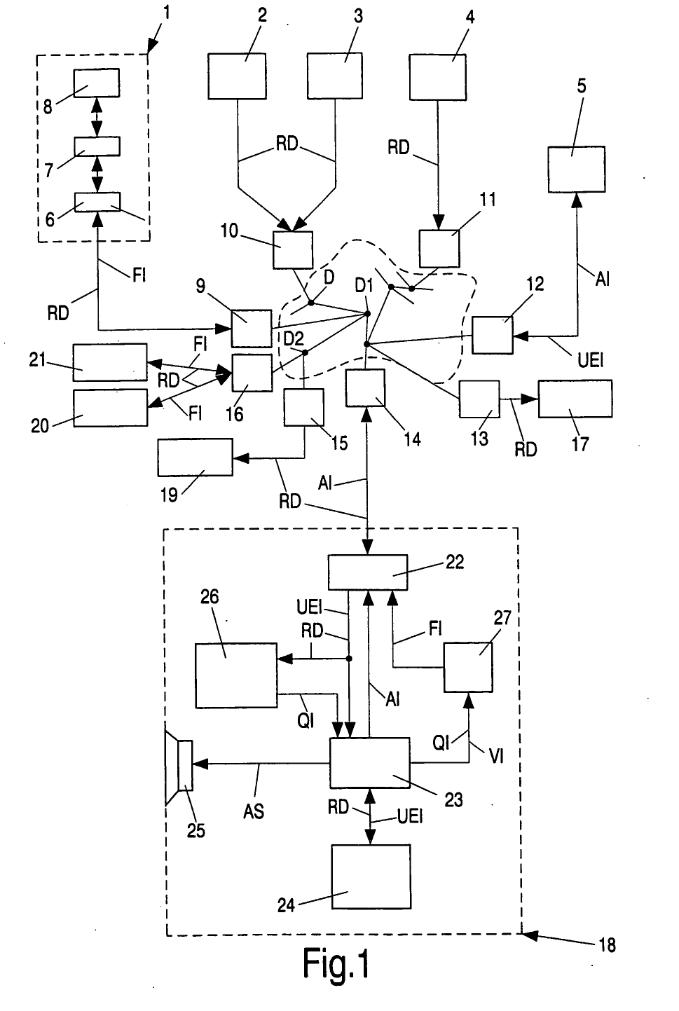

FIG. 1 shows an Internet radio which is designed to receive radio data from radio stations connected to the Internet, wherein the Internet radio outputs feedback information to a program server if the quality of the received radio data does not allow good acoustic reproduction.

FIG. 1 shows a first radio station 1, which is illustrated in detail as a block diagram. The first radio station 1 constitutes an information server for outputting radio data RD of a radio program, wherein the radio data RD constitute information data. A second radio station 2, a third radio station 3, a fourth radio station 4 and a program server 5 likewise constitute information servers, wherein overview information UEI may be output by the program server 5. The overview information UEI identifies the four radio stations 1 to 4 and radio data RD outputtable by the radio stations.

All the information servers comprise interface means 6, processing means 7 and memory means 8. The radio data RD relating to different radio programs are stored in the memory means 8 of the radio stations. The radio data RD of the particular radio program currently intended for broadcast are processed by the processing means 7 and output at the correct time to the interface means 6.

The interface means 6 of the first radio station 1 are connected to the Internet NET via a first service provider 9, the interface means 6 of the second radio station 2 and third radio station 3 are connected via a common second service provider 10, the fourth radio station 4 is connected via a third service provider 11 and the program server 5 is connected via a fourth service provider 12. The service providers 9 to 12 are designed to forward the radio data RD output thereto and the overview information UEI via data network nodes D and data subnetworks of the Internet NET to a fifth service provider 13, a sixth service provider 14, a seventh service provider 15 and an eighth service provider 16. The service providers 13, 14 and 15 respectively connect a first Internet radio 17, a second Internet radio 18 and a third Internet radio 19 with the Internet NET. The eighth service provider 16 connects both a fourth Internet radio 20 and a fifth Internet radio 21 with the Internet NET.

The Internet radios 17 to 21 constitute receivers for receiving radio data RD from radio stations connected with the Internet NET and exhibit the same structure, wherein the second Internet radio 18 is illustrated in detail. The second Internet radio 18 comprises interface means 22, processing means 23 and memory means 24. The interface means 22 take the form of a modem and the processing means 23 take the form of a microcomputer. The interface means 22 and the processing means 23 constitute information retrieval means for retrieving radio data RD from a radio station identified by an Internet address. Corresponding query information AI is output by the interface means 22, via the sixth service provider 14 and the Internet NET, to the respective service provider 9, 10, 11 or 12 and finally to the radio station 1, 2, 3 or 4, whose radio program is to be acoustically reproduced by the second Internet radio 18. Radio data RD received by the interface means 22 may be output to the processing means 23, processed thereby and optionally stored in the memory means 24. An audio signal AS may then be output by the processing means 23 to a loudspeaker 25 for acoustic reproduction of the desired radio program.

The Internet radios 17 to 21 further comprise quality testing means 26, which are designed to test the quality of the received radio data RD and to output quality information QI. The quality testing means 26 test the current data rate of the radio data RD actually received and compare it with the data rate nominally output by the radio station. In addition, the current data rate of the received radio data RD is compared with a minimum data rate, which has to be received in order to ensure fault-free acoustic reproduction of a radio program. In addition, the quality testing means 26 test error redundancy information contained in the received radio data RD and output quality information QI identifying the detected quality of the received radio data RD to the processing means 23.

The Internet radios 17 to 21 additionally comprise feedback means 27, which are designed to output feedback information FI to one of the information servers, wherein the feedback information FI contains the quality information QI and connection information VI identifying the link between the Internet radio and the Internet NET. To detect the connection information VI, the processing means 23 form transmission path detection means, for detecting the transmission path selected for transmission of the radio data RD from the information server to the Internet radio and for outputting the detected connection information VI to the feedback means 27. Such transmission path detection means are known to the person skilled in the art. An example would be the Unix program “traceroute”, which is an implementation of the transmission path detection means and represents the transmission path on the basis of the ICMP (Internet Control Message Protocol). Transmission path detection means draw up a list of all the service providers, data network nodes and data subnetworks which are linked into the transmission path of the radio data RD from the information server to the radio station.

The mode of operation of the radio stations 1 to 4 and the Internet radios 17 to 21, together with the advantages according to the invention thereof, are explained more fully with reference to the first example of application below. According to the example of application, it is assumed that the first radio station 1 outputs radio programs of the radio broadcaster BBC and that the users of all the Internet radios 17 to 21 wish to hear the current radio program broadcast by the BBC. For this purpose, the users actuate appropriate station memory buttons on the Internet radios 17 to 21, under which the Internet address http://www.bbc.co.uk/radio1/realaudio/media/r1live.rpm of the first radio station 1 is stored. The Internet radios then output the query information AI to this Internet address, whereupon the desired radio data RD of the current BBC radio program are output to the Internet radios 17 to 21 by the first radio station 1 via the first service provider 9, data network nodes D and the service providers 13 to 16.

It is also assumed that the fifth service provider 13 and the first Internet radio 17 are located in Germany, the sixth service provider 14 and the second Internet radio 18 in Spain and the seventh service provider 15 and the third Internet radio 19 in Texas, USA. It is additionally assumed that the eighth service provider 16 is in New York, the fourth Internet radio 20 is in New York and the fifth Internet radio 21 is in a suburb of New York. It is assumed that the eighth service provider 16 has technical problems at this moment in time and forwarding of the radio data RD is possible only at a very low data rate.

As described above, the quality testing means 26 of the Internet radios 17 to 21 constantly test the quality of the received radio data RD, wherein the quality testing means 26 of the fourth Internet radio 20 and the fifth Internet radio 21 establish that the data rate of the received radio data RD is too low to allow acoustic reproduction of the radio program of the radio broadcaster BBC. Corresponding quality information QI is then output to the processing means 23 of the Internet radios 20 and 21. The processing means 23 of these two Internet radios 20 and 21 then establish the transmission path of the radio data RD, wherein the following connection information VI is established: first service provider 9—data network node D1—data network node D2—eighth service provider 16.

The feedback means 27 of the fourth Internet radio 20 and of the fifth Internet radio 21 then output the feedback information FI to the first radio station 1, from which the low quality radio data RD were received. The operator of the first radio station 1 thus advantageously receives feedback information FI without delay from the Internet radios 20 and 21, which are having problems receiving the transmitted radio program. By evaluating the quality information QI and connection information VI, the operator may draw conclusions about which measures have to be taken in order to enable the users of Internet radios 20 and 21 also to obtain high-quality reception of the BBC radio program.

According to the example of application, the operator of the first radio station 1 thus knows immediately that the BBC radio program cannot currently be received or can be received only poorly at least in one area of New York. This is very important for operators of radio stations, inter alia because advertising revenues depend on the actual number of listeners. By analyzing the connection information VI of the received feedback information FI, the operator of the first radio station 1 recognizes that there are obviously technical problems with the eighth service provider 16. In addition, the operator of the first radio station 1 recognizes that two Internet radios 20 and 21 cannot receive the BBC due to these technical problems. Depending on how many Internet radios are currently unable to receive the BBC radio program due to technical problems, said operator may draw the attention of the operator of the eighth service provider 16 to the technical problem for the first time or indeed exert pressure to get the problem solved quickly.

Advantageously, only those Internet radios 20 and 21 which are having problems receiving the radio data RD transmit the feedback information FI to the first radio station 1 from which the radio data RD were received, i.e. when the quality information QI detected by the quality means 26 falls below a quality threshold. In this way, the data traffic over the service provider and the Internet NET is advantageously not increased unnecessarily.

If the transmission path over the Internet NET from the radio station to the Internet radio is completely broken and therefore, on the one hand, no radio data RD can be received and also, on the other hand, no feedback information FI can be transmitted over this transmission path to the radio station, the Internet radio may be designed to set up an alternative data connection to said radio station. The feedback information FI could be transmitted over such an alternative data connection, for example as a telephone call, as a fax, by SMS or by radio.

It may be assumed that the first radio station 1 has also received, in addition to the feedback information FI from the Internet radios 20 and 21, feedback information FI from the third Internet radio 19. In this case, the operator of the first radio station 1 would note that all the Internet radios which have problems with reception receive the radio data RD over the data network node D2. By further analysis of the quality information QI transmitted in the feedback information FI, it may be determined whether the technical problems are located in the data network node D2 and/or at the service providers 15 and 16. Advantageously, on the basis of this information the operator of the first radio station 1 may get specific measures under way to improve reception of its radio programs.

According to a second example of application, it is assumed that the program server 5 stores the following table as overview information UEI.

| | Coding of | Nominal | Type of radio | |
|---|---|---|---|---|
| Radio station | radio data | data rate | program | Internet address |
| BBC Radio 1 | real audio | 56 kbit/s | News | http://www.bbc.co.uk/radio1/realaudio/media/r1live.rpm |
| BBC Radio 2 | real audio | 56 kbit/s | News | http://www.bbc.co.uk/radio2/realmedia/fmg2.rpm |
| BBC6/Music | | 96 kbit/s | Music | http://www.bbc.co.uk/6music/ram/dsatg2.rpm |
| WOLF FM | MPEG1/layer3 | 128 kbit/s | The hottest mix | http://205.188.209.193:80/stream/1004 |
| | | | of the 70s, 80s | |
| | | | and today! | |
| EUROPA | MPEG1/layer3 | 24 kbit/s | Live broadcasting | http://www.europaplus.ru/onair.pls |
| PLUS | | | from Moscow. | |
| MOSTLY - | MPEG1/layer3 | 128 kbit/s | Classical Music | http://205.188.209.193:80/stream/1006 |
| CLASSICAL | | | (digitally imported) | |
| XTC.RADIO | MPEG1/layer3 | 160 kbit/s | DJ Excursion Into | http://63.241.4.18:8069 |
| London | | | Trance, Techno and | |
| | | | Progressive House | |

Column 1 of the table contains the names of the radio stations 1 to 4 and further radio stations connected with the Internet NET. The second column of the table contains details of which coding method is used to code the radio data RD retrievable from the radio stations. The third column of the table contains the data rate at which the radio data RD are output by the radio station. So as to enable high-quality acoustic reproduction of the radio programs, this nominal data rate has to be transmissible over the entire transmission path. The fourth column of the table contains the type of radio programs retrievable from the respective radio station and the fifth column contains the Internet address of the respective radio station. Such program servers, especially if they also offer an overview of instantaneous and future program contents, are also known as Electronic Program Guide Servers.

According to the second example of application, it is assumed that the user of the second Internet radio 18 does not yet know which radio program he would like to listen to, for which reason he actuates a program information button on the Internet radio 18. The second Internet radio 18 then transmits corresponding query information AI to the program server 5, which transmits the above-indicated overview information UEI to the second Internet radio 18. This overview information UEI is displayed by a display on the second Internet radio 18 and the user selects the radio station CNN, for example. The radio data RD of CNN's radio programs are then retrieved from the first radio station 1, as described above.

According to the second example of application, it is assumed that a similar process for selecting the first radio station 1 has also been performed with the other Internet radios 17 and 19 to 21. It is additionally assumed that the program server 5 is provided for monitoring the retrievability of the radio data RD. If the first Internet radio 17 and the second Internet radio 18 have problems with reception of the radio data RD from the first radio station 1, these Internet radios 17 and 18 transmit feedback information to the program server 5. The operator of the program server 5 thus advantageously receives feedback information FI from Internet radios in the event of problems with the reception of radio data RD from various radio stations. A large amount of statistical information may be determined therefrom, which may be evaluated on the one hand to solve technical problems and to improve the particular reception problem and on the other hand for market analysis in relation to radio listening habits.

For example, a problem with reception of the radio data RD from the second and third radio stations 2 and 3 could be caused as early in the transmission path as the second service provider 10, a fact which may be readily established by evaluating the feedback information FI. The statistical information determined could also be used to prevent transmission bottlenecks from occurring in the future, by taking it into account in network planning.

It may be mentioned that evaluation of the received feedback information FI could be performed automatically by evaluation means in the radio station or in the program server. In addition, evaluation of the statistical information determined in this way could be performed automatically by a computer, which could transmit fault report information automatically to the respective service providers or operators of data network nodes. In this way, operators of service providers and data networks would be automatically informed of problems, for which reason such fault report information is transmitted in particular to those operators of service providers and data networks which pay for it.

It may be mentioned that the above-described invention may be used for any desired information data (e.g. video data, text data etc.) and any desired information servers (e.g. Internet radio station, Internet television station, Video On Demand server, Electronic Program Guide server etc.) and any desired receivers (e.g. Internet radio, DVD recorder, television set etc.). Likewise, the invention may be used in any desired data networks (e.g. LAN, WAN, telephone network etc.).

It may be mentioned that any desired server connected with the respective data network may be provided for monitoring the retrievability of the information data. Likewise, any desired other means (e.g. telephone exchange, receiver manufacturer etc.) may be provided over one of the above-mentioned alternative data connections for monitoring the retrievability of the information data and automatically generating fault information.

It may be mentioned that a large number of options are known to the person skilled in the art for testing the quality of received information data and outputting quality information corresponding to the test result.

1. A receiver (17, 18, 19, 20, 21) for receiving information data (RD) from information servers (1, 2, 3, 4, 5) connected with a data network (NET), having
information retrieval means (22, 23) for retrieving information data (RD) from one of the information servers (1,2, 3, 4, 5) identified by data network addresses and having
receiving means (22) for receiving the retrieved information data (RD) from the information server (1, 2, 3, 4, 5) and having
quality testing means (26) for testing the quality of the received information data (RD) and for outputting quality information (QI),
characterized in that feedback means (27) are provided, which are designed to output feedback information (FI) to one of the information servers (1, 2, 3, 4, 5), wherein the feedback information (FI) contains the quality information (QI) and connection information (VI) identifying the link between the receiver (17, 18, 19, 20, 21) and the data network (NET).

2. A receiver (17, 18, 19, 20, 21) as claimed in claim 1, characterized in that the feedback means (27) are designed to output feedback information (FI) to the information server (1, 2, 3, 4, 5) from which the information data (RD) were retrieved.

3. A receiver (17, 18, 19, 20, 21) as claimed in claim 1, characterized in that the information retrieval means (22, 23) are designed to retrieve overview information (UEI) from an overview information server (5) connected to the data network (NET), wherein the overview information (UEI) identifies information servers (1, 2, 3, 4, 5) and information data (RD) retrievable from these information servers (1, 2, 3, 4, 5), and in that the feedback means (27) are designed to output the feedback information (FI) to the overview information server (5).

4. A receiver (17, 18, 19, 20,21) as claimed in claim 1, characterized in that the connection information (VI) output by the feedback means (27) identifies the service provider (13, 14, 15, 16) over which the receiver (17, 18, 19, 20, 21) is connected with the data network (NET).

5. A receiver (17, 18, 19, 20, 21) as claimed in claim 1, characterized in that the quality information (QI) output by the feedback means (27) identifies the bandwidth, the average bit rate received and/or the actual profile of the bit rate of the received information data (RD).

6. A receiver (17, 18, 19, 20, 21) as claimed in claim 1, characterized in that the feedback means (27) are designed to output feedback information (FI) only when the quality information (QI) identifies a quality of received information data (RD) which is below a quality threshold.

7. A receiver (17, 18, 19, 20, 21) as claimed in claim 1, characterized in that the feedback means (27) are designed to set up an alternative data connection to the information server (1, 2, 3, 4, 5) and to output the feedback information (FI) to the information server (1, 2, 3, 4, 5) over this alternative data connection if it has proved impossible to set up a data connection to the information server (1, 2, 3, 4, 5) over the data network (NET).

8. A receiver (17, 18, 19, 20, 21) as claimed in claim 1, characterized in that transmission path detection means (23) are provided, which are designed to detect the transmission path selected for transmission from the information server (1, 2, 3, 4, 5) to the receiver (17, 18, 19, 20, 21) and to output the thus detected connection information (VI) to the feedback means (27).

9. A receiving method for generating feedback information (FI), having a receiver (17, 18, 19, 20, 21), connected with a data network (NET), for an information server (1, 2, 3, 4, 5) connected with the data network (NET), the following steps being executed:
retrieval of the information data (RD) from one of the information servers (1, 2, 3, 4, 5) identified by data network addresses and
reception of the retrieved information data (RD) from the information server (1, 2, 3, 4, 5) and
testing of the quality of the received information data (RD) and outputting of quality information (QI),
characterized in that feedback information (FI) is output to one of the information servers (1, 2, 3, 4, 5), wherein the feedback information (FI) contains the quality information (QI) and connection information (VI) identifying the link between the receiver (17, 18, 19, 20, 21) and the data network (NET).

10. A receiving method as claimed in claim 9, characterized in that the feedback information (FI) is output to the information server (1, 2, 3, 4, 5) from which the information data (RD) were retrieved.

11. A receiving method as claimed in claim 9, characterized in that overview information (UEI) is retrieved from an overview information server (5) connected to the data network (NET), wherein the overview information (UEI) identifies information servers (1, 2, 3, 4, 5) and information data (RD) retrievable from these information servers (1, 2, 3, 4, 5), and in that the feedback information (FI) relating to the retrieved information data (RD) is output to the overview information server (5).

12. An overview information server (5) for outputting overview information (UEI) to a receiver (17, 18, 19, 20, 21) connected over a data network (NET), wherein the overview information (UEI) identifies information servers (1, 2, 3, 4, 5) and information data (RD) retrievable from these information servers (1, 2, 3, 4, 5) with the receiver (17, 18, 19, 20, 21), said overview information server having
receiving means (6) for receiving query information (AI) from a receiver (17, 18, 19, 20, 21) for retrieving the overview information (UEI) and having
memory means (8) for storing the overview information (UEI) and having
transmitting means (6) for transmitting the stored overview information (UEI) to the retrieving receiver (17, 18, 19, 20, 21),
characterized in that the receiving means (6) are designed to receive feedback information (FI) containing quality information (QI) and connection information (VI), wherein the quality information (QI) identifies the quality of the information data (RD) received by the receiver (17, 18, 19, 20, 21) from one of the information servers (1, 2, 3, 4, 5) and the connection information (VI) identifies the link between the receiver (17, 18, 19, 20, 21) and the data network (NET).

13. An overview information server (5) as claimed in claim 12, characterized in that evaluation means (7) are provided for evaluating the received feedback information (FI) and outputting fault report information which identifies those parts of the data network (NET) which are responsible for poor quality information data (RD) received by the receivers (17, 18, 19, 20, 21).

14. An overview information server (5) as claimed in claim 13, characterized in that the transmitting means (6) are designed to output the fault report information to service providers (13, 14, 15, 16) so as to improve the quality of the information data (RD) received by the receivers (17, 18, 19, 20, 21).
